(19) United States
(12) Patent Application Publication
(10) Pub. No.: US 2010/0251740 A1
(43) Pub. Date: Oct. 7, 2010

(54) ICE DISPENSER WITH AN ICE COMMINUTING DEVICE

(75) Inventors: Gerald Schmidt, Gerstetten (DE); Daniel Winter, Dischingen (DE); Kasim Yazan, Ulm (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/681,001

(22) PCT Filed: Sep. 17, 2008
(86) PCT No.: PCT/EP2008/062353

§ 371 Date: Mar. 31, 2010

(30) Foreign Application Priority Data
Oct. 10, 2007 (DE) 10 2007 048 573.7

(51) Int. Cl. F25C 5/02; B02C 18/06

(52) U.S. Cl. 62/320; 241/101.1; 241/236

(57) ABSTRACT

An ice dispenser for dispensing ice that includes a housing having an inlet opening for introducing uncomminuted pieces of ice into the housing and an outlet opening for dispensing at least one of the uncomminuted pieces of ice or comminuted pieces of ice from the housing. The ice dispenser further includes an ice comminution device including a rotatable shaft supporting a blade arrangement and a counterblade arrangement operable to rotate along with the rotatable shaft, and a locking device, wherein based on a position of the locking device, the counterblade arrangement is operated to rotate along with the shaft or to be fixed with the housing. In an exemplary embodiment of the invention, the at least one counterblade of the counterblade arrangement includes a catch for engaging with a counter-catch of the locking device. As such, an undesired release of the counter blade for the locking means may be prevented.

The present invention relates to an ice dispenser for dispensing ice cubes or comminuted ice flakes, with a housing, an inlet opening for introduction of the ice cubes into the housing, an outlet opening for dispensing the optionally uncomminuted ice cubes or the comminuted ice flakes from the housing as well as an ice comminuting device, featuring a driven shaft on which are supported a blade arrangement which rotates with the shaft and a counterblade arrangement which, depending on a position of a locking device, is optionally operated to rotate with the shaft or to be fixed in relation to the housing.

A dispensing and comminuting device for small pieces of ice is known from DE 40 13 925 A1. In this invention three segment sections pivotable around an axis provided with a common support are provided with a smooth surface like a part of a cylinder. These segment sections can be inserted by a solenoid drive through the side dispensing cutout of the projection support between the transport elements. The insertion of the segment sections is delimited by a stop. The segment sections are withdrawn while pretensioning a compression spring when the solenoid drive is not powered from the turning circle of the transport elements and in such cases no longer penetrate into the projection support. In a “dispensing of non-comminuted ice cubes” operating position the transport elements are used to eject the pieces of ice conveyed forwards by the worm drive and move these for ejection through the side dispensing cutout. The lower part of the projection support which remains stationary forms a water return channel by which water dripping off the ice cubes is directed back into the storage container. In a “comminuting” operating setting the toothed bar-type transport elements press the ice cube against the smooth surface of the segment sections inserted completely into their spaces through the side dispensing cutout. In such cases an ice cube is comminuted in each case and its fragments fall through the dispensing cutout open to the side. In this operating position the segment sections provided with a common support are applied to the fixed point on the housing by the solenoid drive against the action of the screw compression spring.

U.S. Pat. No. 6,109,476 describes a dispensing and comminuting device for ice flakes constructed in the same way as DE 40 13 825 A1 with a blade supported in a stationary manner pivotably in the housing.

A dispenser for ice cubes and crushed pieces of ice is known from U.S. Pat. No. 5,056,688. The dispenser in this patent has a rotatable shaft to which three rotating ice crusher arms are attached in a parallel spacing from one another and coaxially to each other. Two rotating ice crusher arms in each case delimit an intermediate space for one stationary ice crusher arm in each case. The two stationary ice crusher arms provided for the three rotating ice crusher arms are each supported by means of their central ends on the shaft. For this purpose the central ends of the stationary ice crusher arms feature circular breakthroughs through which the shaft is fed. The shaft can turn freely in the circular breakthroughs so that the stationary ice crusher arms do not rotate along with the rotation of the shaft but remain at a standstill. The outer ends lying opposite the central end of each stationary ice crusher arm are rigidly connected by a means of attachment to the housing. As well as the rotating ice crusher arms and the stationary ice crusher arms two barrier arms are also provided. The barrier arms release a dispensing channel for non-crushed ice cubes in a direction of rotation of the shaft in which the cutting blades of the rotating ice crusher arms lag behind the smooth backs of their blades. In an opposite direction of rotation of the shaft in which the cutting teeth of the rotating comminuting arms are leading the smooth backs of their blades, the barrier arms block off the dispensing channel for non-crushed ice cubes so that the ice cubes are conveyed onto the cutting teeth of the stationary crusher arms and are crushed there. The crushed flakes of ice then fall through gaps between the stationary comminuting arms out of the dispenser.

A generic ice dispenser is described in U.S. Pat. No. 4,176,527. Supported on the shaft of the dispensing and comminuting device are both rotating and also stationary comminuting arms. To hold the stationary comminuting arms supported rotatably on the shaft, a spring pretensioned latching lever is supported on the housing which can be pivoted into a blade orbit of the stationary comminuting arms. In the locked position an area of the backs of the blades of the stationary comminuting arms close to the circumference rests against a stop surface of the locking lever, so that the stationary comminuting arms are held in a fixed position relative to the housing and can no longer rotate with the shaft. Since the diameter of the rotating comminuting arms is smaller than the penetration depth of the locking lever, the rotating comminuting arms can continue to rotate driven by the shaft. Since only an area of the backs of the blades of the stationary comminuting arms close to the circumference rests against the stop surface of the locking lever, there is the danger of the stationary comminuting arms, if high comminution forces occur, jumping over the stop surface of the locking lever or of the locking lever deflecting so that the stationary comminuting arms rotate as well. This has the disadvantage that, in comminuting operation, uncomminuted pieces of ice also reach the dispenser although this is not desired.

The object of the invention is to reduce the danger of insufficiently comminuted ice flakes being dispensed during comminution operation of the ice dispenser.

The object is achieved by an ice dispenser with the features of claim 1.

By at least one counterblade of the counterblade arrangement having a catch for engaging with a counter catch of the locking device, any undesired release of the counterblades from the lock is prevented. The shape of the catch and the corresponding counter catch make such meshing possible so that the locking device is retained in its locking position by the at least one counterblade so that a deflection of the locking device cannot occur even on occurrence of high comminuting forces. Previously the locking device was always only touched on one side by a least one counterblade. Inventively the locking device is now gripped from two opposing sides so that it can no longer bend away from the at least one counterblade. A release of the locking device would result in the counterblades to be held rigidly in relation to the housing continuing to rotate along with the shaft in an undesired manner and consequently no ice flakes being comminuted since there would be no counterblades working against the rotating blades. Therefore a release of the locking device can result in an undesired dispensing of uncomminuted pieces of ice or pieces of ice not comminuted to the desired small size. The fact that it is inventively assured that the counterblades reliably remain in their fixed position in relation to the housing means that an expected high comminution is always reliably guaranteed.

In normal ice comminution devices two different sets of blades are located on a common shaft. One set of blades always turns along with the shaft, the second set of blades can rotate freely around the shaft. When the choice is to dispense whole ice cubes, the second set of blades moves through the ice cubes as well. When comminuted ice is being dispensed this second set of blades will be held by a locking device so that the individual ice cubes are comminuted between the retained set of blades and the set of blades connected rigidly to the shaft and therefore rotating. It has been established that because of the forces occurring during comminution it can occur under some circumstances that the actual retained set of blades twists and because of this can spring out from the lock and it can be that whole ice cubes are dispensed although comminuted ice cubes are actually required. A possible solution is to make the entire system more stiff by pressure being exerted on the entire blade arrangement through an additional coil spring in the axial direction of the shaft. Since during comminution forces acting on a specific point only occur very briefly, this reduces the probability of twisting and thereby the probability of jumping. Simultaneously however the probability of the drive motor stopping because of an overload is increased. In addition the probability increases that when the mode of operation is changed from comminution to production of ice cubes in the dispensing of uncomminuted ice cubes or ice cubes the locking device does not return to its initial position since it is being held back by a spring. This spring can however not be dimensioned with any given strength since the spring force during locking must be additionally overcome. The aim is therefore to find a locking device which reliably prevents springing back but simultaneously does not exert any additional force on the motor.

The upper end of the stationary set of blades is inventively modified so that the locking device engages into the blades instead of getting in the way of the blades as a barrier. The barrier locking method has the advantage that the locking device can first be left down and subsequently the set of blades to be held back, which is connected to a transverse lock, is pressed by the rotation of the shaft against this barrier and in the further comminution process is held in its position by the ice. With the modified inventive blades too the locking device can continue to be left down at first. It can be ensured by a suitable design of the blade and also as a result of the play present in the overall system that the locking device can slide up onto the blade end and then drop into the catch. The forces occurring during comminution are relatively unpredictable in their direction but they always only occur for a short period. Therefore it is sufficient to select the catch to be deep enough without further specific retaining means being necessary for it. The locking device remains despite this in the catch during the comminution and cannot jump out. The unlocking is also reliably possible in a simple manner through a simple indentation. This is all the easier the more smoothly the blades which are lockable in their position are attached to the axis.

In an inventive design of the blades and of the locking device the reliability of the system for the user is increased. On the one hand the design prevents the unwanted penetration of the entire ice cubes during the comminution on the other hand the overall blade structure on the shaft can be designed to be relatively loose. In this way the probability is reduced of the motor blocking as a result of forces which are too high. In addition a plurality of parts must be mounted on the shaft for the set of blades, with a relatively loose structure with play the tolerances of the individual parts are less critical than with the previous solutions.

The catch can inventively feature a cutout for engagement with a counter catch of the locking device. The counter catch can especially be designed as a type of finger. The cutout can be embodied as a cutout open on one edge on the circumference of the catch. In this case two opposing flanks are formed by the open-edge design between which the counter catch of the locking device inserts itself. This means that the locking device is held in its position from two opposing sides. The two opposing sides or the flanks of the open-edge cut out preferably run in a radial direction to the axis of the drive shaft. The two opposing sides or the flanks respectively restrict the movements of the counter catch or of the locking device both in the direction of rotation and also against the direction of rotation of the comminution device. The counter catch or the locking device is to this extent fixed in both circumferential directions by the catch above the counterblade itself. In all embodiments the catch can optionally be provided for a single or for a number or for all counterblades present.

The cutout can especially be arranged at an end of the counterblade away from the shaft support. Although the arrangement just described with the locking device being gripped by opposing flanks can be achieved using a catch which is connected at a given point to the at least one counterblade, it is proposed that the catch be provided in an area of the counterblade away from the shaft support, especially in the vicinity or directly on the circumferential end of the counterblade. The advantage of this is that, for comparable torques on the shaft, only smaller retaining forces to keep the counterblade locked in place are necessary than would be the case were the cutout to be provided at a point of the counterblade at a short distance from the shaft. The cutout can be arranged on a circumferential end face of the counterblade or arranged at the radial height of a transverse bar connecting a number of counterblades. The arrangement of the cutout to the side at the radial height of a transverse bar connecting a number of counterblades has the advantage that the retaining forces which are to be introduced through the locking device via the cutout into the counterblade will be introduced at the radial height of the transverse bar into the counterblade and thereby no torques are introduced by the locking device into the transverse bar.

The cutout is preferably embodied for radial engagement of the locking device into the counterblade. When the locking device can engage in a radial direction into the cutout this means that the locking device can also only slip in a radial direction out of the cutout again. Since for a rotation of the counterblade both in the clockwise direction and also in the counterclockwise direction forces only occur in the circumferential direction, only forces perpendicular to the slide out direction for the locking device can be introduced by the counterblade. This means that even for introduction of forces as a result of a high torque, no forces are generated which could force the locking device out of the cutout. The consequence of this is that the locking device remains reliably in the cutout even if high comminution forces occur.

When the ice dispenser switches over from its operating mode of dispensing uncomminuted ice flakes into the operating mode for dispensing comminuted ice flakes, the locking device must drop into the cutout in order to be able to lock the at least one counterblade in its position. To this end it must be ensured that the locking device can also drop into its cutout during a rotation of the counterblade. An insertion edge is provided that this purpose.

In this case the catch can feature a leading insertion edge in the direction of rotation of the cutout for switching the locking device from a pre-locking position in which the counterblade is out of the engagement with the locking device, into a drop-in position from which the locking device can drop in a radial direction into the cutout of the catch. If the counterblade is not locked it can turn along with the shaft. If the ice dispenser is put by the user into the operating mode for comminuting ice flakes, it can be that the locking device pivots into the blade orbit of the ice comminution device, i.e. the locking device moves beyond the outer circumference of the rotating blades inwards in the direction of the shaft. This occurs when the locking device pivots inwards at a point at which the counterblade is located in a turned-away position. If subsequently the counterblade, as a result of its rotation, runs up against the locking device, the counterblade would merely be stopped resting on one side of the locking device. The inventive leading insertion edge means that because of the rotation movement of the counterblade the locking device is again pivoted radially outwards so that it can get over the open-edged recess of the cutout from outside and then can drop directly into the cutout. To this extent the leading insertion edge ensures that the locking device can engage in any rotating position of the counterblade reliably into the cutout and can keep the counterblade locked in position.

In addition the catch can feature a trailing insertion edge in the direction of rotation of the cutouts for preventing the locking device jumping out of the cutout. To guarantee an easy release of the locking device for a change of operating mode from comminuted mode into the mode for dispensing uncomminuted ice cubes, the locking device is only pretensioned with a rather low spring pretensioned force against the catch. If the counterblade is now rotating at a relatively high speed, it could occur that the locking device which is forcibly pivoted outwards radially beyond the insertion edge cannot impart a sufficient spring force quickly enough to let the locking device spring back into the cutout at the right time. As a result the counterblade would rotate below the locking device without the counterblade being able to be locked in its position. In order to prevent such a shaking out of the counterblade, the cutout is provided with a trailing stop edge. The stop edge brakes the counterblade if the locking device cannot engage in the cutout and lets the locking device hitting the stop edge spring back into the cutout. The stop edge thus prevents an undesired further rotation of the counterblade.

The stop edge can be formed by an edge of the cutout which is increased in height. Alternatively the stop edge can be formed by a transverse bar connecting a number of counterblades. An extended edge of the cutout and a transverse bar can also be used jointly and to this extent by the double embodiment of stop edges redundantly and thereby safely prevent an undesired further rotation of the counterblade. A transverse bar is also used to couple together a number of counterblades arranged in parallel to each other so that these always circulate on the shaft synchronously with each other.

In all inventive variants the catch, the cutout and/or the stop edge can be embodied in one piece with the at least one counterblade of the counterblade arrangement. In this way the number of the parts needed is reduced and the ice dispenser can be manufactured at low cost. In particular the counterblades can be prefabricated from a punched blank with corresponding contour.

The counter catch can be embodied by a projection-like pin connected to the locking device. The locking device can be embodied in one piece with such molded projections which engage into the cutouts. Since however the impact-type stresses on the projections are very high it is advantageous to realize the projections in the form of fingers by separate pins which can be manufactured from hard material, such as steel pins for example. Any danger of the finger-type projections shearing off is excluded by the use of special steel pins.

The invention relates especially also to refrigerators having an ice maker with an inventive ice dispenser.

An embodiment of the invention is described with reference to an ice dispenser in a refrigerator for domestic purposes shown by way of example in the figures. Further general features and advantages of the present invention also emerge from the more detailed description of the concrete exemplary embodiments.

The figures show:

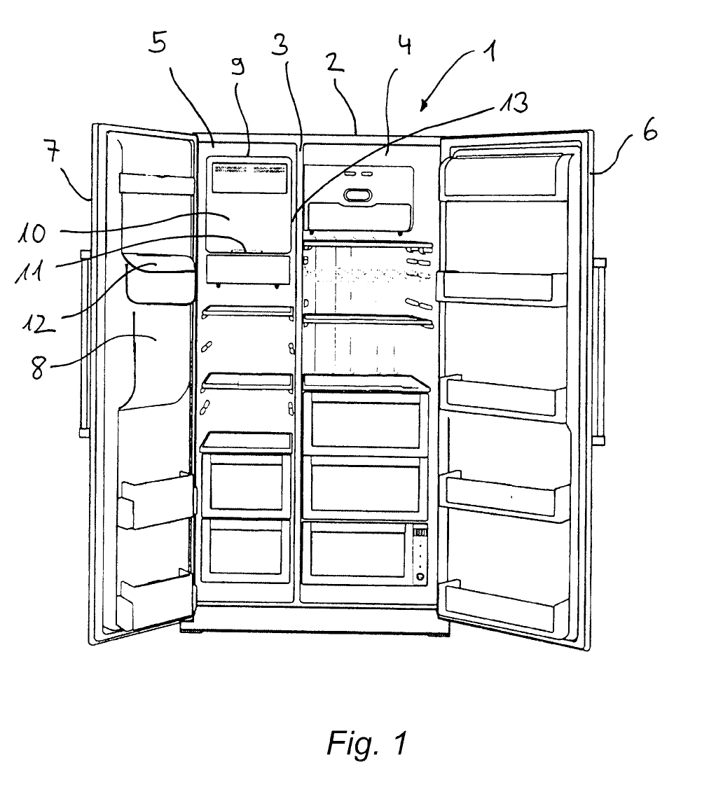

FIG. 1 a perspective view of a refrigerator for domestic purposes with an ice dispenser;

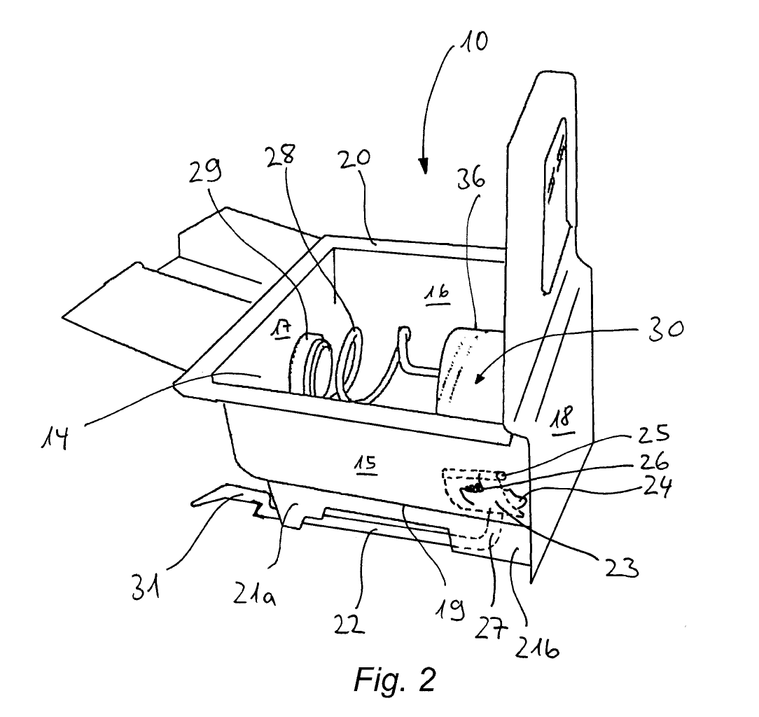

FIG. 2 a perspective view of a container of the ice dispenser in accordance with FIG. 1 for storage of prepared ice cubes with a comminution device;

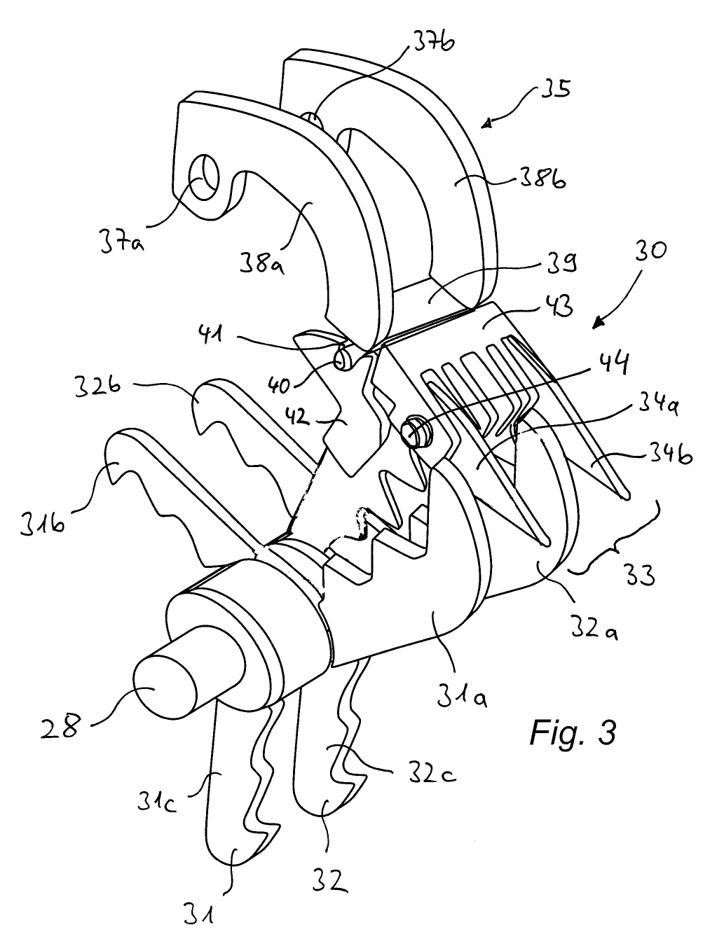

FIG. 3 a blade arrangement of the ice comminution device in accordance with FIG. 2;

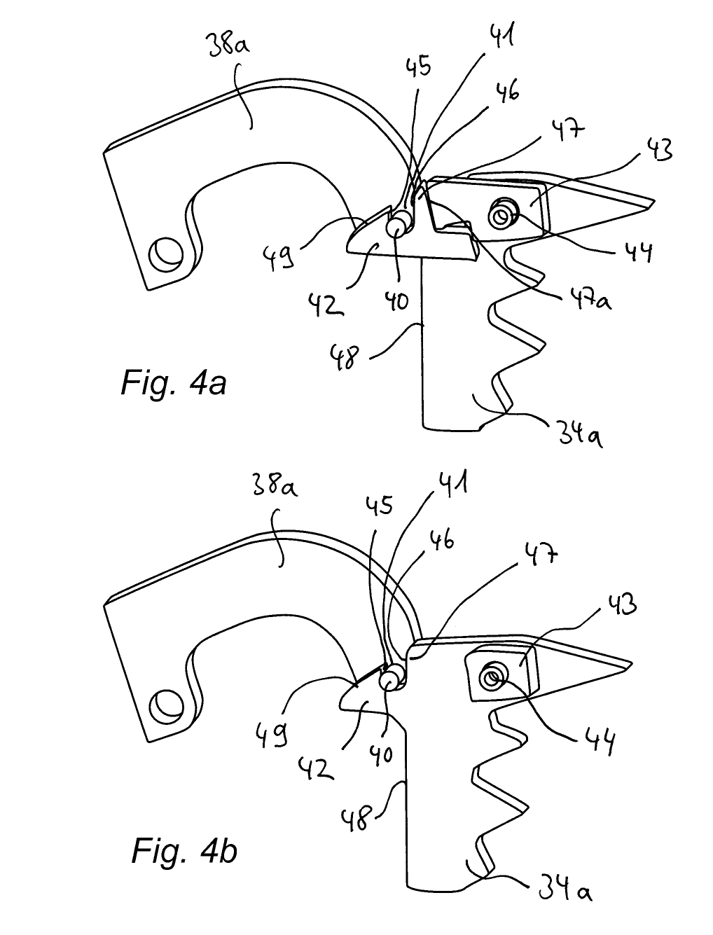

FIG. 4a a first, multipart embodiment of an inventive catch and counter catch;

FIG. 4b a second one-piece embodiment of an inventive catch.

A refrigerator 1 in accordance with FIG. 1 has a thermally-insulated housing cabinet 2 which is divided by a partition wall 3 into a refrigeration compartment 4 shown on the right in the figure and a freezer compartment 5 shown on the left in the figure. The refrigerator compartment 4 is able to be closed off by a first door 6 and the freezer compartment 5 by a second door 7. The second door 7 of the freezer compartment 5 features a dispensing unit 8 for optionally dispensing ice cubes or crushed ice. The ice cubes are created in an ice maker 9 which is arranged on the ceiling side within the freezer compartment 5 and ejects the finished ice cubes on a lower side of the ice maker 9. The ice cubes fall from above into a container 10 for intermediate storage. At a lower opening 11 on the front of the container 10 the ice cubes can be conveyed if required out of the container and fall via an output chute provided on the inside of the second door 7 outwards on the front of the second door 7. For cleaning purposes in particular the container 10 is able to be removed from the refrigerator 1 from a holder 13 of the freezer compartment 5.

The container 10 removed from the refrigerator 1 is shown on its own in FIG. 2. The container 10 features a bowl-shaped collection dish 14 with a first sidewall 15 shown in the foreground and a second sidewall 16 shown in the background, as well as a rear wall 17 shown to the left, a front wall 18 shown to the right and a base 19. Running along the top edges of the sidewalls 15, 16 and the rear wall 17 is an edge section 20 projecting out horizontally which forms a support rail to enable the container 10 to be pushed in and pulled out like a drawer on assigned rail supports of the holder 13 within the freezer compartment 5 of the refrigerator 1. Arranged on the underside of the container 10 on the floor 19 are foot sections 21a and 21b. Rotatably supported on the foot sections 21a and 21b is a control shaft 22. The control shaft 22 is used to actuate a closure device 23 which in its closed position closes off an opening 24 on the floor of the container 10. To hold the closure device 23, which can be embodied as a simple flap, in the closed position, the closure device 23 is supported by a hinge 25 on the container and kept in the closed position by the tension of a spring 26. The closure device 23 is connected to one end 27 of the control shaft 22 such that a rotational movement of the control shaft 22 effects an opening movement of the closure device 23. When the closure device 23 is open, ice cubes which are in the container 10 can fall downwards out of the container 10 via the opening 24 on its base 19. To convey ice cubes into the area of the opening 24 a shaft 28 is supported in the container which is able to be driven via a coupling element 29 supported in the rear wall by a motor arranged in the refrigerator when the container 10 is located in the operating position in the holder 13. In the front area of the shaft 28 an ice comminution device 30 which is operated via the shaft 28 is provided for making crushed ice. To open and close

the closure device 23 a lever 31 is provided on the control shaft 22 at the rear in the vicinity of the rear wall 17, i.e. at the rear end of the control shaft 22 shown on the left in FIG. 2, via which the ice comminution device 30 is able to be toggled between the operating mode “ice cube dispensing” and the operating mode “crushing”.

The ice comminution device 30 is explained in greater detail in FIG. 3. On the shaft 28, with an axial spacing between them, are two blade arrangements 31 and 32 attached to the shaft. The first blade arrangement 31 has three individual blades 31a, 31b and 31c each aligned offset by 120°. Each individual blade 31a, 31b and 31c bears blade teeth of which the tips of the teeth point as shown in FIG. 3 in a counterclockwise direction. In the same way the second blade arrangement bears three individual blades 32a, 32b and 32c each aligned offset by 120°. Each individual blade 32a, 32b and 32c bears blade teeth of which the tips of the teeth point as shown in FIG. 3 in a counterclockwise direction. The blade arrangement 31 and the blade arrangement 32 are consequently arranged in parallel to one another and aligned in the same direction. Positioned between the blade arrangement 31 and the blade arrangement 32 is a first counterblade arrangement 33. The counterblade arrangement 33 has a first individual counterblade 34a and a second individual counterblade 34b which are both fixed axially on the shaft 28 but which can turn on the shaft in the circumferential direction largely freely in relation to the shaft 28. The individual counterblades 34a and 34b bear blade teeth of which the tips of the teeth point as shown in FIG. 3 in a clockwise direction. The tips of the blade teeth of the individual counterblades 34a and 34b are consequently aligned in the opposite direction to the tips of the blades of the blade teeth of the individual blades 31a, 31b and 31c and the individual blades 32a, 32b and 32c.

Because of a slight axial tensioning of the blade arrangement 31, the blade arrangement 32 and the counterblade arrangement 33 the individual counterblades 34a and 34b rotate unhindered along with the shaft 28 and the blade arrangements 31 and 32. In this operating mode there is no comminution of pieces of ice since the individual counterblades 34a and 34b are rotating at the same speed as the blade arrangements 31 and 32. Above the counterblade arrangement 33 is a locking device 35 supported pivotably in a housing 36 (FIG. 2). The locking device 35 has two locking arms 38a and 38b running in parallel, the housing-side ends of which are provided with support eyes 37a and 37b in order to support the locking arms 38a and 38b pivotably on the housing 36. Arranged on an end of the locking arms 38a and 38b lying opposite one of the support eyes 37a and 37b is a locking plate 39. The locking plate 39 bears a pin 40. In the locking position shown in FIG. 3 the counterblade arrangement 33 is shown in an arrangement in which it is held in position relative to the housing 36 in which a comminution of ice flakes can take place. In this case the blade arrangements 31 and 32 rotate with the shaft 28 and the counterblade arrangement 33 stands still so that the blade teeth of the individual blades 31a, 31b and 31c and of the individual blades 32a, 32b and 32c run against the blade teeth of the individual counterblades 34a and 34b and pieces of ice coming between these teeth are comminuted. The counterblade arrangement 33 is kept in position by the pin 40 of the locking device 35 engaging in a cutout 41 of a catch 42. The catch 42 is connected to the counterblade arrangement 33. A transverse lock 43 connects the two individual counterblades 34a and 34b via a spring clip 44. The catch 42 is only shown in FIG. 3 on the front individual counterblade 34a. A separate catch 42 can however preferably be provided on each individual counterblade 34a and 34b.

Two variants of a locking device 30 with counter catch 40 and assigned catch 42 are shown in FIGS. 4a and 4b. To simplify the diagrams only one individual arrangement is shown. FIG. 4a shows a counterblade 34a to which the catch 42 is attached as a separate component. The counterblade 34a is shown in cutaway view and on its long edge running opposite to the direction of rotation of the shaft 28 (FIG. 3) it has three blade teeth. A long side of the counterblade 34a lying opposite one of the blade teeth is embodied as a straight back of the blade 48. On an end of the counterblade 34a located on the circumferential side of the circle of blades an end section of the transverse lock 43 is shown. The transverse lock 43 is provided for connecting a number of counterblades 34a and is attached by the spring clip 44 to the counterblade 34a. To this end both the counterblade 34a and also the transverse lock 43 have a hole for the spring clip 44. The catch 42 is arranged at least approximately at the height of this transverse lock 43. As a separate component, as shown in FIG. 4a, the catch 42 will be attached to a side surface of the counterblade 34a. The catch 42 features the cutout 41. The cutout 41 is formed by a U-shaped contour section on the upper end of the catch. The cutout 41 is to this extent embodied open at its top edge. Between a leading arm edge 45 and a trailing arm edge 46 of the U-shaped contour section of the cutout 41 lies the counter catch 40 embodied as a pin engaging in the form of a finger. The pin is held in FIG. 4a to the left of the pin by the leading arm edge 41 and to the right of the pin by the trailing arm edge 46. The trailing arm edge 46 is elongated in a direction pointing radially outwards, in FIG. 4a upwards, in order to form a stop edge 47. The stop edge 47 reliably prevent the pin being able to jump out over the cutout to the right over the entire counterblade 34a. A face side in the direction of rotation of the shaft 28, i.e. a leading end face side of the transverse lock 43 can form an alternate or further stop edge 47a. Thus the stop edge 47 could be omitted and the stop edge 47a moved slightly forwards to form the trailing arm edge 46 of the U-shaped cutout 41. As shown in FIG. 4a the stop edge 47a of the transverse lock 43 supports the stop edge 47 of the catch 42 also present.

FIG. 4b shows a counterblade 34a which is manufactured with the catch 42 as a one-piece component. The catch 42 as described for FIG. 4a is an identical design but in one piece, i.e. embodied as one piece with the counterblade. The leading arm edge 46 is formed in this case by the back of the blade 48. A further stop edge 47a is dispensed with in the example shown. Unlike the position of the U-shaped cutout shown in the example in the upper area of the back of the blade 48, the U-shaped cutout 41 can also be arranged on the circumferential side, i.e. in FIG. 4b above the counterblade 34a. In both variants of FIG. 4a and FIG. 4b a starting chamfer 49 is positioned in front of the leading arm edge 45 of the U-shaped cutout 41. The starting chamfer 49 begins at the height of a smaller circumference and the orbit of the blades, then runs with an increasing radial spacing from the axis of rotation of the counterblade 34a or of the shaft to 28 at an angle upwards to the upper edge of the leading arm edge 45 of the U-shaped cutout 41. The starting chamfer 49 must begin at a height of a smaller circumference which is at least slightly smaller than the radial position of the counter catch 40 when the locking device 30 is pivoted into the circle of blades of the ice comminution device 30 without dropping into the counterblade 34a. After a renewed orbit of the counterblade 34a the counter catch rides up onto the starting chamfer 49. If the counterblade 34a now rotates further in a counterclockwise direction, the counter catch 14 slides upwards along the starting chamfer 49 and from there can drop into the U-shaped cutout 41 and hold the counterblade 34a in position and prevent a further rotation. The counterblade 34a is thus reliably held in position by the locking device 35.

1-10. (canceled)

11. An ice dispenser for dispensing ice, the ice dispenser comprising:
a housing having an inlet opening for introducing uncomminuted pieces of ice into the housing and an outlet opening for dispensing at least one of the uncomminuted pieces of ice or comminuted pieces of ice from the housing;
an ice comminution device including a rotatable shaft supporting a blade arrangement and a counterblade arrangement operable to rotate along with the rotatable shaft; and
a locking device, wherein based on a position of the locking device, the counterblade arrangement is operated to rotate along with the shaft or to be fixed with the housing, wherein at least one counterblade of the counterblade arrangement includes a catch for engaging with a counter-catch of the locking device.

12. The ice dispenser as claimed in claim 11, wherein the catch includes a cutout for engaging with a finger-like counter-catch of the locking device.

13. The ice dispenser as claimed in claim 12, wherein the cutout is arranged on an end of the at least one counterblade opposite a shaft support.

14. The ice dispenser as claimed in claim 12, wherein the cutout radially engages the locking device in the at least one counterblade.

15. The ice dispenser as claimed in claim 14, wherein the catch includes a leading starting chamfer in a direction of rotation of the cutout for changing the locking device from a pre-locking position, in which the at least one counterblade is out of engagement with the locking device, into a drop-down position from which the locking device can drop down in a radial direction into the cutout of the catch.

16. The ice dispenser as claimed in claim 15, wherein the catch includes a trailing stop edge in the direction of rotation of the cutout for preventing the locking device jumping out of the cutout.

17. The ice dispenser as claimed in claim 16, wherein the trailing stop edge is formed by a transverse lock connecting a number of counterblades.

18. The ice dispenser as claimed in claim 16, wherein at least one of the catch, the cutout, and the trailing stop edge are structured as one piece with the at least one counterblade.

19. The ice dispenser as claimed in claim 12, wherein the finger-like counter catch is formed by a pin connected to the locking device.

20. A refrigerator, the refrigerator comprising:
an ice dispenser for dispensing ice, the ice dispenser including:
a housing having an inlet opening for introducing uncomminuted pieces of ice into the housing and an outlet opening for dispensing at least one of the uncomminuted pieces of ice or comminuted pieces of ice from the housing;
an ice comminution device including a rotatable shaft supporting a blade arrangement and a counterblade arrangement operable to rotate along with the rotatable shaft; and
a locking device, wherein based on a position of the locking device, the counterblade arrangement is operated to rotate along with the shaft or to be fixed with the housing, wherein at least one counterblade of the counterblade arrangement includes a catch for engaging with a counter-catch of the locking device.
